(19) United States
(12) Patent Application Publication
(10) Pub. No.: US 2012/0274548 A1
(43) Pub. Date: Nov. 1, 2012

(54) PLIABLE FINGERTIP KEY DEPRESSOR FOR USE WITH SMALL KEYBOARDS

(76) Inventor: Pamela Molen, Dayton, OH (US)

(21) Appl. No.: 13/307,051

(22) Filed: Nov. 30, 2011

Related U.S. Application Data
(60) Provisional application No. 61/479,107, filed on Apr. 26, 2011.

(51) Int. Cl. G09G 5/00

(52) U.S. Cl. 345/156

(57) ABSTRACT

An apparatus for depressing keys on a small keyboard is disclosed. The apparatus includes a flexible substrate including a first surface, a second surface opposite the first surface, a first peripheral end portion, and a second peripheral end portion opposite the first end portion. An adhesive is coupled to the first surface of the flexible substrate such that the substrate may be attached to a digit on the user's hand, e.g., the user's thumb. When the apparatus is attached to a user's thumb, the first peripheral end portion does not touch the second peripheral end portion. Moreover, the apparatus includes a nodule that extends outwardly from the second surface of the flexible substrate such that when the substrate is attached to the user's thumb the nodule is outwardly positioned on the user's thumb, wherein the nodule is smaller than the tip of the user's thumb.

### CROSS-REFERENCE TO RELATED APPLICATIONS

This application claims priority to U.S. provisional patent application No. 61/479,107 filed Apr. 26, 2011 entitled PLIABLE FINGERTIP KEY DEPRESSOR FOR USE WITH SMALL KEYBOARDS, the disclosure of which is incorporated herein by reference.

### BACKGROUND

The present invention relates generally to the field of entering information into a device and more specifically to the field of entering information using a small keyboard of a handheld device.

Users routinely enter information into computing devices using a keyboard. In general, a keyboard comprises a plurality of keys where each key represents a character, such as a letter, number, or punctuation. Moreover, many modern keyboards also accommodate modifier keys that, when pressed either alone or in combination with other keys, implement task specific functions. For example, modifier keys may be used to temporarily repurpose a selected key to a new character, trigger the execution of shortcuts, control peripherals, etc. In this regard, one or more keys may represent a single character, or the keys may represent different characters depending upon the context or key combination pressed by the user.

The advent of semiconductors that consume low enough power to be operated from a portable rechargeable battery has led to handheld devices such as smart phones, personal digital assistant (PDA), and pervasive computing devices, which include a built-in keyboard. However, in order to keep the devices small enough to be handheld, the keyboard on the hand-held device must also be small. In this regard, the keys on a keyboard are generally proportional to the overall size of the keyboard, and the size of the keyboard is constrained by the size of the hand-held device.

### SUMMARY OF THE INVENTION

According to aspects of the present invention, an apparatus for entering information using a data entry device is disclosed. The apparatus is suitable, for example for depressing or otherwise touching keys or other features on a small keyboard, display, etc. The apparatus, designated herein as a pliable fingertip key depressor, includes a flexible substrate that has adhesive on a first side and a nodule that extends from the opposite side thereof. A user applies the flexible substrate to a hand digit (e.g., the user's thumb or finger) so that the adhesive temporarily holds the substrate to the digit. Because the substrate is flexible, the user can shape the substrate to conform to the digit such that the nodule is positioned conveniently for entering information on a small keyboard.

According to further aspects of the present invention, the flexible substrate includes a first surface, a second surface opposite the first surface, a first peripheral end portion, and a second peripheral end portion opposite the first peripheral end portion. An adhesive is coupled to the first surface of the flexible substrate such that when the substrate is attached to a user's digit, the second surface faces outward. Moreover, a nodule extends outwardly from the second surface of the flexible substrate such that when the substrate is attached to the user's digit, the nodule is outwardly positioned on the user's digit.

Thus, in operation, a user entering information on a small keyboard (e.g., texting on a smart phone) can apply a pliable fingertip key depressor to the thumb of each hand, for instance. Once the key depressors have been applied, the user can operate the small keyboard by using the nodules to contact the keys on the keyboard. Accordingly, the user is not required to use the pad of the user's fingers or thumbs. In this regard, the nodules of the key depressors facilitate relatively more precision in contacting desired keys, compared to using the pads of finger digits, thus more accurately entering information.

According to further aspects of the present invention, a pliable fingertip key depressor for depressing or otherwise touching keys on a small keyboard includes a flexible substrate including a first surface, a second surface opposite the first surface, a first peripheral end portion, and a second peripheral end portion opposite the first end portion. An adhesive is coupled to the first surface of the flexible substrate such that the substrate is suitable to attach to a digit on the user's hand (e.g., the user's thumb or finger). When the apparatus is attached to a user's digit, the first peripheral end portion does not touch the second peripheral end portion. Moreover, the apparatus includes a nodule that extends outwardly from the second surface when the substrate is attached to the user's digit. The nodule is smaller than the pad of the user's digit and is dimensioned generally to correspond with the size of anticipated keys on a small keyboard.

According to further aspects of the present invention, a method for depressing keys on a small keyboard is disclosed. The method includes attaching a flexible substrate with adhesive to a user's hand digit, e.g., thumb or finger, wherein the flexible substrate includes a nodule facing outward from the digit to which the substrate is applied. The nodule provides a surface for contacting the keys or features of a data input device (e.g., keys of a small keyboard) with enough force to register the entry of the desired input.

### BRIEF DESCRIPTION OF THE DRAWINGS

The following detailed description, which describes various embodiments and other aspects of the present invention, can be best understood when read in conjunction with the following drawings, where like elements are indicated with like reference numerals, and in which:

FIG. 1 is a schematic top view of a pliable fingertip key depressor having a generally rectangular shape, according to aspects of the present invention;

FIG. 2 is a schematic top view of a pliable fingertip key depressor according to further aspects of the of the present invention, wherein the top view has a nonrectangular shape;

FIG. 3 is a schematic side view of the pliable fingertip key depressor according to FIG. 1 or 2;

FIG. 4 is a side view of an embodiment of the pliable fingertip key depressor of the present invention attached to a user's thumb in a latitudinal orientation;

FIG. 5 is a side view of an embodiment of the pliable fingertip key depressor of the present invention attached to a user's thumb in a longitudinal orientation; and

FIG. 6 is a side view of an embodiment of the pliable fingertip key depressor of the present invention attached to a user's thumb, oriented so that a nodule of the depressor is positioned to the side of the thumb pad.

For simplicity and clarity of illustration, elements shown in the figures have not necessarily been drawn to scale. For example, the dimensions of some of the elements may be exaggerated relative to other elements for clarity of discussion.

### DETAILED DESCRIPTION OF THE INVENTION

Various aspects of the present invention provide a device to assist a user when typing on a data entry device. By way of illustration, the device is suitable to assist a user interfacing with a data entry device such as a small keyboard on a smart phone, PDA, pervasive computing device, or other hand-held processing device. The device is also suitable to assist a user when interfacing with a data entry device such as a touchscreen, keyboard, or other keypad of a device such as a point of sale terminal, kiosk, data terminal, automated teller machine (ATM), or other structure requiring the user to enter information into a digital processing device.

In general, various aspects of the present invention provide a pliable fingertip key depressor that adheres to a digit, such as the thumb or finger, on the user's hand. The pliable fingertip key depressor includes a nodule that forms a protrusion from the user's digit. The nodule is preferably smaller than a key on a keyboard that the user intends to interact with, which allows the user to more precisely select desired keys on the small keyboard.

The pliable fingertip key depressor facilitates positioning of the nodule anywhere about the user's digit (e.g., at the finger or thumb tip) on the pad area opposite the nail, to the side of the digit, or at any other desired position that is comfortable for the user to enter information into a keyboard or other data entry device. Moreover, the user can wear multiple pliable fingertip key depressors (e.g., one on each thumb, one or more on each of a plurality of fingers, etc). This facilitates entering information into a data entry device (e.g., a small keyboard such as for texting on a smart phone).

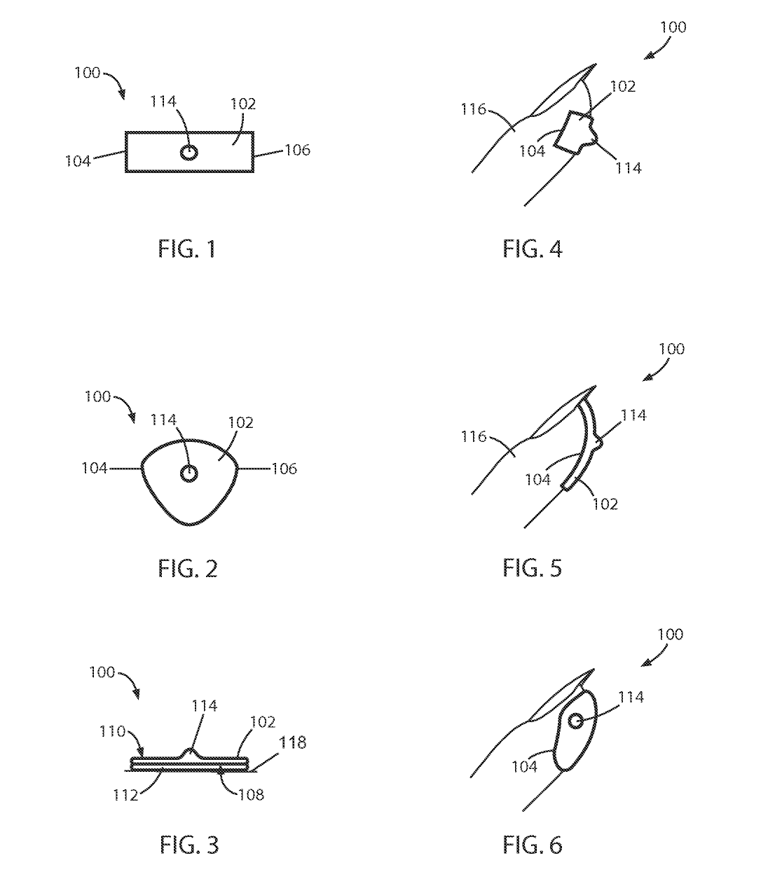

Referring now to the drawings, and in particular, to FIG. 1, a top view of a pliable fingertip key depressor 100 is illustrated having a generally rectangular shape. Although illustrated as rectangular, the top view of the pliable fingertip key depressor 100 may alternatively take on a nonrectangular shape. In this regard, the shape may be polygonal, curvilinear, or the shape may include a combination of curvilinear portions and linear portions.

For example, referring briefly to FIG. 2, a top view of the pliable fingertip key depressor 100 may take a shape having a generally rounded portion illustrated towards the top of the pliable fingertip key depressor 100 in FIG. 2 and a generally elongated, curved or beveled portion illustrated towards the bottom of the pliable fingertip key depressor 100 in FIG. 2. In this regard, the shape illustrated in FIG. 2 resembles a Reuleaux triangle, shield, or similar shape. Referring briefly to FIG. 3, a side view of the pliable fingertip key depressor 100, as illustrated in either FIG. 1 or FIG. 2, comprises in general, at least two layers, including a substrate layer and an adhesive layer, as will be described in greater detail herein.

Referring generally to FIGS. 1-2, the pliable fingertip key depressor 100 includes a flexible substrate 102 having a first peripheral end portion 104 and a second peripheral end portion 106. In general, the first peripheral end portion 104 and the second peripheral end portion 106 are defined based upon the shape of the flexible substrate 102 and represent portions of the flexible substrate 102 that are wrapped partially around the user's digit when the pliable fingertip key depressor 100 is worn.

For example, as illustrated in FIG. 1, the shape of the pliable fingertip key depressor 100 from a top view is rectangular. As such, the first peripheral end portion 104 and the second peripheral end portion 106 may comprise opposite edges. Moreover, as illustrated, the opposing first peripheral end portion 104 and second peripheral end portion 106 are along the minor length, i.e., are perpendicular to the major length of the rectangular shape. In this configuration, it is anticipated that the user will apply the pliable fingertip key depressor 100 such that the major length wraps at least partially about the user's digit.

As noted above, the shape of the pliable fingertip key depressor 100 from a top view may be non-rectangular. In this regard, the first peripheral end portion 104 and the second peripheral end portion 106 comprise opposing peripheral portions along the circumference. The location of the first peripheral end portion 104 and second peripheral end portion 106 may be along the circumference at opposite locations defining a maximum lateral span across the pliable fingertip key depressor 100. Alternatively, the location need not correspond to opposite circumference positions along the maximum span.

For instance, in FIG. 2, the first peripheral end portion 104 and the second peripheral end portion 106 comprise opposing apexes of a Reuleaux triangular, shield, or other similar shape. In this manner, when a user applies the pliable fingertip depressor 100, the opposing apexes would wrap at least partially around the user's digit.

Moreover, the first peripheral end portion 104 and the second peripheral end portion 106 may each be represented by a pair of opposite points along the periphery in certain implementations. For instance, a flexible substrate 102 having a top view shape that is generally circular, elliptical or other curved shape, may define the first peripheral end portion 104 and the second peripheral end portion 106 where a diameter crosses two points on the circumference.

The flexible substrate 102 may be made out of a material such as, but not limited to: cloth, vinyl, an elastomer, foam, etc. In this manner, the flexible substrate 102 is pliable enough to conform to the contours of the user's digit (e.g., the user's finger or thumb) as will be described in greater detail herein. In this regard, the flexible substrate 102 is not rigid and is easy to manipulate. For instance, as a first illustrative example, the flexible substrate 102 may be sufficiently pliant that if a user places the flexible substrate 102 on a flat surface, then the flexible substrate 102 will become flat or can be easily flattened. In an illustrative example, if the user holds the flexible substrate horizontally by the first end portion 104, then gravity will manipulate the flexible substrate 102 such that the second end portion 106 bends generally downward toward the ground. However, such need not be the case. Rather, the flexible substrate 102 may possess some amount of rigidity so long as the flexible substrate 102 can be conformed substantially to a digit of an individual.

As an illustrative example, the flexible substrate 102 may have some stiffness associated therewith. However, the flexible substrate 102 is conformable about user's digit. As yet another illustrative example, the flexible substrate 102 may be stretchable so as to facilitate conforming about a digit on the hand of the user. Thus, depending upon the implementation, the flexible substrate 102 may be stretchable, or it may be sufficient for the flexible substrate 102 to bend or flex to conform to the digit on the user's hand without stretching the flexible substrate 102. Moreover, the flexible substrate 102 may be elastic or inelastic.

Referring to FIG. 3, the flexible substrate 102 includes a first surface 108 and a second surface 110, which are on opposite sides of the flexible substrate 102. An adhesive 112 such as an epoxy covers at least a portion of the first surface 108 and may cover the entire first surface 108. The adhesive 112 is meant to form a temporary but secure bond such that the pliable fingertip key depressor 100 stays securely attached to the user's digit (e.g., thumb) but may be easily removed after use. In this regard, the adhesive 112 may be of a type that does not leave a residue on the user's skin when the pliable fingertip key depressor 100 is removed from the user's hand. Moreover, the adhesive 112 may remain tacky enough to allow the user to pull off and quickly re-apply the pliable fingertip key depressor 100 (e.g., to reposition or otherwise adjust the placement of the pliable fingertip key depressor 100 on the user's digit).

A nodule 114 extends from the second surface 110 of the flexible substrate 102. When the user is wearing the pliable fingertip key depressor 100 on a hand digit (e.g., the thumb) the nodule 114 faces away from the thumb such that the nodule 114 may be used to press keys. In an illustrative example, the nodule 114 is dimensioned such that the tip of the nodule 114 is not bigger than the keys anticipated to be pressed. However, the nodule 114 should be large enough that the keys of the small keyboard can be pressed without the second surface 110 of the flexible substrate 102 or the user's thumb hitting other keys of the small keyboard. Further, the nodule 114 should be sufficiently rigid to depress keys on a corresponding data entry device and will thus likely be more rigid than the flexible substrate 102. As an illustrative example, the nodule 114 may be integral with the flexible substrate 102, i.e., coupled to the flexible substrate 102. As another illustrative example, the nodule 114 can be trapped within sealed, mating layers of the flexible substrate 102. In this regard, the nodule 114 may be fixedly positioned, or the user may be able to relocate the nodule 114 to a desired position between the sealed and mated layers. The nodule 114 can alternatively extend through or otherwise attach to the flexible substrate 102.

FIG. 3 also illustrates a release layer 118 that is provided to temporarily cover and protect the adhesive 112 prior to use. Particularly, the release layer 118 sandwiches the adhesive 112 between the release layer 118 and the first surface 108 of the flexible substrate 102. The release layer 118 is any suitable layer that will lightly hold to the flexible substrate 102 and corresponding adhesive layer 112 but allow the user to easily remove the release layer 118 from the adhesive layer 112. The user peels the flexible substrate 102 from the release layer 118. The release layer 118 allows the adhesive 112 to release and remain with the flexible substrate 102.

Referring now to FIG. 4, a side view illustrates an embodiment of the pliable fingertip key depressor 100 attached to a user's digit 116 (e.g., a finger or thumb). The user attaches the pliable fingertip key depressor 100 to a digit by contacting the adhesive 112 on the second surface 108 of the flexible substrate 102 to the skin of the thumb. The user then pushes the flexible substrate 102 to conform to the digit of the hand to which the flexible substrate 102 is applied. The flexible substrate 102 adheres to and stays on the user's thumb or finger due to the adhesive 112. Thus, the flexible substrate 102 is not required to wrap entirely around the user's digit, and the pliable fingertip key depressor 100 may rest on a portion of the user's digit (e.g., the user's thumb tip, pad/thumbprint, side of the thumb, or other desired position).

As further illustrated, the pliable fingertip key depressor 100 is attached to the user's digit in a latitudinal orientation. The latitudinal orientation is an orientation where the flexible substrate 102 is adhered to the digit 116 along the circumference of the digit 116. In the exemplary implementation, if the flexible substrate 102 imaginarily extended past its true dimensions, then the imaginary flexible substrate 102 would wrap entirely around the digit 116 like a ring. However, the flexible substrate 102 does not need to wrap entirely around the digit 116 because the flexible substrate 102 is attached to the thumb by the adhesive (112, FIG. 2). FIG. 4 illustrates a first exemplary positioning of the nodule 114, which is generally centered on the pad of the digit opposite the nail, e.g., fingernail or thumbnail.

Referring now to FIG. 5, a side view illustrates an embodiment of the pliable fingertip key depressor 100 attached to a user's digit 116 in a longitudinal orientation. The longitudinal orientation is an orientation perpendicular to the latitudinal orientation on the surface of the digit 116 illustrated in FIG. 4. Even though the longitudinal orientation may be used to position the nodule 114 anywhere on the digit 116, the longitudinal orientation is illustrated positioning the nodule 114 on or near the tip of the thumb 114 to demonstrate yet another illustrative position of the nodule 114 relative to the digit.

Referring now to FIG. 6, a side view illustrates an embodiment of the pliable fingertip key depressor 100 attached to a user's digit 116 such that the nodule 114 is oriented towards the side between the pad and nail of the digit.

The positioning of the nodule 114 in FIGS. 4-6 is presented by way of illustration and not by way of limitation. In practice, a user may position the nodule 114 to any position that facilitates assistance in the entry of information into a data entry device as described in further detail herein.

According to various aspects of the present invention, the nodule 114 is dimensioned for use with data entry devices such as keyboards as typically found on portable handheld devices, such as but not limited to smart phones, PDAs, etc. Notably, the tip of the nodule 114 is smaller than an adult fingertip. As such, the nodule 114 facilitates accurately targeting and depressing keys or data entry areas on small keyboards. Correspondingly, an adult attempting to type on a small keyboard without the assistance from the pliable fingertip key depressor 100 may inadvertently press multiple keys or the wrong key.

Moreover, the nodule 114 can be positioned, for example, to the side of the digit such as a thumb, e.g., as illustrated in FIG. 6. In this regard, the physical size of the user's digits will not obscure the user's view of the keyboard, especially the view of the intended key and neighboring keys of the intended key. As such, a user has more accuracy due to placement and/or visual cues when typing on keyboards. This may be useful, for example, when the user is operating on a data entry device that the user is unfamiliar with, e.g., a keyboard that does not fully implement a traditional QUERTY key layout.

Even though the disclosure and examples herein refer to attaching a pliable fingertip key depressor to a user's digit such as the user's thumb, the pliable fingertip key depressor may be attached to any of the user's digits, including fingers or the thumb. Moreover, while a single pliable finger tip depressor 100 is illustrated for purposes of clarity of disclosure, a user may in practice, utilize more than one pliable finger tip depressor 100. For instance, a user may utilize a finger tip depressor 100 on each thumb. In this regard, in general, a user may wear a finger tip depressor on each of a plurality of digits, on one or both hands.

As an illustrative example, with the pliable fingertip key depressor 100, a user can isolate and press a key on a small keyboard without pressing other keys on the keyboard. For example, a user wants to send a text message on a smart phone. However, the user's “texting thumbs” are large, and the user usually presses several keys when trying to press just one key. The user can attach the pliable fingertip key depressor 100 to each thumb by contacting the adhesive 112 on the second surface 108 of the flexible substrate 102 to the thumb. With the nodule 114 facing outward, the nodule is used to contact and press the desired keystroke combination on the smart phone keyboard.

Further, because the method for attaching the pliable fingertip key depressor 100 to the user's digit is the adhesive 112, the depressor 100 may be positioned on the user's digit in any orientation, preferably in an orientation where pressing keys with the nodule 114 is comfortable for the user. Thus, the user is not at the mercy of a prefabricated rigid ring or other fitted apparatus for depressing keys. Moreover, since the pliable fingertip key depressor 100 is temporarily adhered to the user's digits in a manner that is conformal to the digit, the device is universally sized to fit all users. This avoids the potential problems of a ring or other such fitted device that would not fit everyone's thumb the same way, and which would result in many users having the apparatus positioned in an uncomfortable position.

In several embodiments, the nodule 114 is made of, or otherwise contains a conductive material, e.g., conductive thread, that is integrated with the nodule 114 in such a way as to form a circuit with the finger, thumb, etc., to which the key depressor 100 is applied. In such embodiments, the depressor 100 is suitable for use, even with capacitive-sensing touchscreens. Even though the depressor 100 is not used to depress keys, it is used to select virtual keys on the touchscreen. The virtual keys may be alphanumeric keys, icons, specific areas of the touchscreen, individual pixels of the touchscreen, etc. One example of such a virtual key on a touchscreen is a keyboard drawn to the screen of a smartphone, tablet computer, handheld computer, etc. Another example of a virtual key on a touchscreen is a key drawn on a register at a fast food restaurant. A further example of a virtual key on the touchscreen is within a signature box on a credit card swipe machine, where the individual pixels of the signature box are the virtual keys. Still further examples include a screen of a point of sale terminal, kiosk, data terminal, automated teller machine (ATM), etc.

When the user is finished typing, the pliable fingertip key depressor(s) 100 can be easily peeled off and thrown away. The disposability of the depressor 100 allows for an inexpensive way to prevent the user's finger from coming into contact with keys, screens and other devices, thus promoting sanitation and usefulness in sanitary applications. Thus, the depressors 100 may be used to prevent germs, microbes, etc., from being transferred between the user and a data entry device. Such is advantageous, especially where the data entry device is open for use by the public. After use on a public surface, the user may remove and dispose of the depressor 100. Still further, the key depressors 100 are useful for preventing smudges, smears, oil residue from fingers, fingerprints etc., from being transferred from the user to the key or touchscreen.

Due to the small profile and size, the pliable fingertip key depressor 100 does not interfere with conventional activities that require the use of one's hands. Moreover, the adhesive 112 allows the key depressor(s) 100 to remain temporarily adhered to the digit(s) of a user throughout many normal activities. As such, the pliable fingertip key depressor(s) 100 may be worn for extended periods of time, even when not typing on a data entry device such as a small keyboard.

As noted in greater detail herein, the key depressor 100 is suitable for use with keys, buttons, pads, etc., which are physical devices found on data entry devices. For instance, the key depressors 100 are suitable for use with keypads and keyboards with tactile response or otherwise physical structures that require depression to activate. The key depressor 100 is also suitable for use with touchscreens found on smartphones, tablet computers, touch screens on laptops and other computers, kiosks, point of sale terminals, data collection devices, etc., regardless of whether such devices provide or require a tactile response, simulated tactile response, physical contact or proximity thereto.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. Aspects of the invention were chosen and described in order to best explain the principles of the invention and the practical application, and to enable others of ordinary skill in the art to understand the invention for various embodiments with various modifications as are suited to the particular use contemplated.

1. An apparatus for entering information using a data entry device, the apparatus comprising:
a flexible substrate including a first surface, a second surface opposite the first surface, a first peripheral end portion, and a second peripheral end portion opposite the first peripheral end portion;
an adhesive coupled to the first surface of the flexible substrate such that when the substrate is attached to a user's digit, the second surface faces outward; and
a nodule that extends outwardly from the second surface of the flexible substrate such that when the substrate is attached to the user's digit, the nodule is outwardly positioned on the user's digit.

2. (canceled)

3. The apparatus of claim 1, wherein the adhesive covers the entire second surface of the flexible substrate.

4. The apparatus of claim 1, wherein the flexible substrate is stretchable to conform to the digit of the user.

5. The apparatus of claim 1, wherein the nodule is relatively stiffer than the flexible substrate.

6. The apparatus of claim 1, wherein the nodule and flexible substrate form a circuit with the digit of a user so as to be suitable for use with capacitive touchscreen data input devices.

7. A method for entering information using a data entry device, the method comprising:
attaching a flexible substrate with adhesive to a user's digit, wherein the flexible substrate includes a nodule facing outward from the digit; and
contacting the inputs of a data entry device with the nodule with enough force to register the entry of the desired input.

8. (canceled)

9. (canceled)

10. The method of claim 7, wherein attaching a flexible substrate with adhesive to a user's digit includes attaching the flexible substrate with adhesive to the user's thumb.

11. An apparatus for selecting virtual keys on a touchscreen, the apparatus comprising:
a flexible substrate including a first surface, a second surface opposite the first surface, a first peripheral end portion, and a second peripheral end portion opposite the first peripheral end portion;
an adhesive coupled to the first surface of the flexible substrate such that when the substrate is attached to a user's digit, the second surface faces outward and the first peripheral end portion does not touch the second peripheral end portion; and
a nodule that extends outwardly from the second surface of the flexible substrate such that when the substrate is attached to the user's finger, the nodule is outwardly positioned on the user's finger, the nodule comprising a conductive material.

12. The apparatus of claim 1, wherein the flexible substrate is in a general shape of a circle.

13. The apparatus of claim 1, wherein the flexible substrate is in a general shape of a Reuleaux triangle.

14. The apparatus of claim 1, wherein the flexible substrate is in a general shape of a shield.

15. The apparatus of claim 1, wherein the flexible substrate is in a general shape of a rectangle.

16. The apparatus of claim 1, wherein the flexible substrate is formed a pliant material such that when placed on a flat surface, the flexible substrate becomes generally flat.

17. The method of claim 7, wherein attaching a flexible substrate further includes attaching the flexible substrate to the user's digit such that a tip of the user's digit is partially covered.

18. The method of claim 7, wherein attaching a flexible substrate further includes attaching the flexible substrate to the user's digit such that a tip of the user's digit is entirely covered.

19. The apparatus of claim 11, wherein the flexible substrate is in a general shape of a circle.

20. The apparatus of claim 11, wherein the flexible substrate is in a general shape of a Reuleaux triangle.

21. The apparatus of claim 11, wherein the flexible substrate is in a general shape of a shield.

22. The apparatus of claim 11, wherein the flexible substrate is in a general shape of a rectangle.

23. The apparatus of claim 11, wherein the flexible substrate is formed a pliant material such that when placed on a flat surface, the flexible substrate becomes generally flat.
